(19) United States
(12) Patent Application Publication
(10) Pub. No.: US 2004/0066353 A1
(43) Pub. Date: Apr. 8, 2004

(54) Antenna mounting methods and apparatus

(76) Inventors: Mathias Martin Ernest Ehlen, Upper Hutt (NZ); John Heywood Thomson, Wellington (NZ); Jamie M. Paske, Darien, IL (US); Danny R. Knight, Munster, IN (US)

Correspondence Address: Welsh & Katz, Ltd., Eric D. Cohen, 22nd Floor, 120 South Riverside Plaza, Chicago, IL, 60606, US

(21) Appl. No.: 10/263,481

(22) Filed: Oct. 3, 2002

(51) Int. Cl. H01Q 1/12

(52) U.S. Cl. 343/891; 343/892

(57) ABSTRACT

A method of mounting an antenna to a support, the method including the steps of: a) mounting first and second clamps to the support; b) tightening the first clamp around the support; c) mounting the antenna to the first clamp; d) after step c), moving the second clamp along the support away from the first clamp into engagement with the antenna; and e) tightening the second clamp around the support. The antenna is suspended from the first clamp by gripping the antenna below its upper end; lifting the upper end of the antenna over the first clamp mounted at an elevated position; and lowering the upper end of the antenna onto the first clamp so that interlocking male and female parts of the clamp and the antenna couple together. The clamp has three or more clamping members and three or more tighteners which can each be adjusted to tighten together a respective pair of adjacent clamping members so as to tighten the clamp around the support. The clamp can be provided in kit form. The clamping members have a body portion with an inner side with one or more springs for gripping the support.

### FIELD OF THE INVENTION

The present invention relates to a method of mounting an antenna to support; a clamp; and an antenna mounting kit.

### DESCRIPTION OF THE RELATED ART

A known clamp kit from Kathrein (type nos 742 263, 742 033 and 742 034) includes a three-sector clamp and a mounting support clamp. Each antenna is mounted on a respective part of the three sector clamp. The mounting support clamp is in the form of a band which is tightened round the mast to fix the three-sector clamp in place.

### BRIEF DESCRIPTION OF EXEMPLARY EMBODIMENT

The exemplary embodiments of the invention provides a method of mounting an antenna to a support, the method including the steps of: a) mounting first and second clamps to the support; b) tightening the first clamp around the support; c) mounting the antenna to the first clamp; d) after step c), moving the second clamp along the support away from the first clamp into engagement with the antenna; and e) tightening the second clamp around the support.

It will be appreciated that steps a)-e) may be performed in sequence a), b), c), d), e), or may be performed in a different sequence. Also, some of the steps a)-e) may be performed simultaneously. However in general step d) must be performed after step c).

An exemplary embodiment also provides a method of mounting an antenna to a support, the method including the steps of: a) mounting a clamp to the support at an elevated position; b) gripping the antenna below its upper end; c) lifting the upper end of the antenna over the clamp mounted at the elevated position; d) lowering the upper end of the antenna onto the clamp so that interlocking male and female parts of the clamp and the antenna couple together; and e) securing a lower end of the antenna to the support.

The exemplary embodiments also provide a clamp for mounting three or more antennas to a support, the clamp comprising three or more clamping members which can be mounted around the support, each clamping member being configured to support a respective antenna; and three or more tighteners which can each be adjusted to tighten together a respective pair of adjacent clamping members so as to tighten the clamp around the support.

This clamp is specially suited for use in the exemplary method. That is, the tightening members can be used to tighten the first clamp around the support in step b), and also to tighten the second clamp around the support in step e).

An exemplary embodiment also provides an antenna assembly mounting kit including a pair of clamps each having three or more clamping members which can be mounted around a support; six or more antenna mounting members each for coupling a respective antenna to a respective clamping member, wherein the clamping members and mounting members have interlocking parts which permit a pivoting motion between each mounting member and its respective clamping member; and six or more securing members for securing the mounting members and clamping members together to prevent said pivoting motion.

This kit is also specially suited for use in the exemplary method. That is, the antenna can be pivoted away from the support to provide access to the second clamp in step d).

### BRIEF DESCRIPTION OF THE DRAWINGS

Illustrative embodiments of the invention will now be described with reference to the accompanying drawings to disclose the advantageous teachings of the present invention.

FIG. 1 is a perspective view of an antenna site;

FIG. 2 is a plan view of the antenna site of FIG. 1;

FIG. 3 is an isometric view of an antenna mounting bracket;

FIG. 4 is a plan view of the 3-sector bracket assembly;

FIG. 5 is an end view of the bracket assembly;

FIG. 6 is an isometric view of the bracket assembly;

FIG. 7 is an isometric view of a filler panel;

FIG. 8 is a plan view of the filler panel;

FIG. 9 is a rear view of the filler panel;

FIG. 10 is an enlarged isometric view of the top of the filler panel;

FIGS. 11a-11f show different steps in a method of assembling the antenna assembly of FIG. 1;

FIG. 12 is an end view of an alternative bracket assembly with tapered mounting pins;

FIG. 13 is an isometric view of the alternative bracket assembly with tapered mounting pins;

FIG. 14 is an enlarged isometric view of the top of an alternative filler panel adapted for mounting on the bracket assembly of FIGS. 12 and 13; and

FIG. 15 is an enlarged view showing the assembly of the antennas onto the pin mounts.

### DETAILED DESCRIPTION OF EMBODIMENT OF THE INVENTION

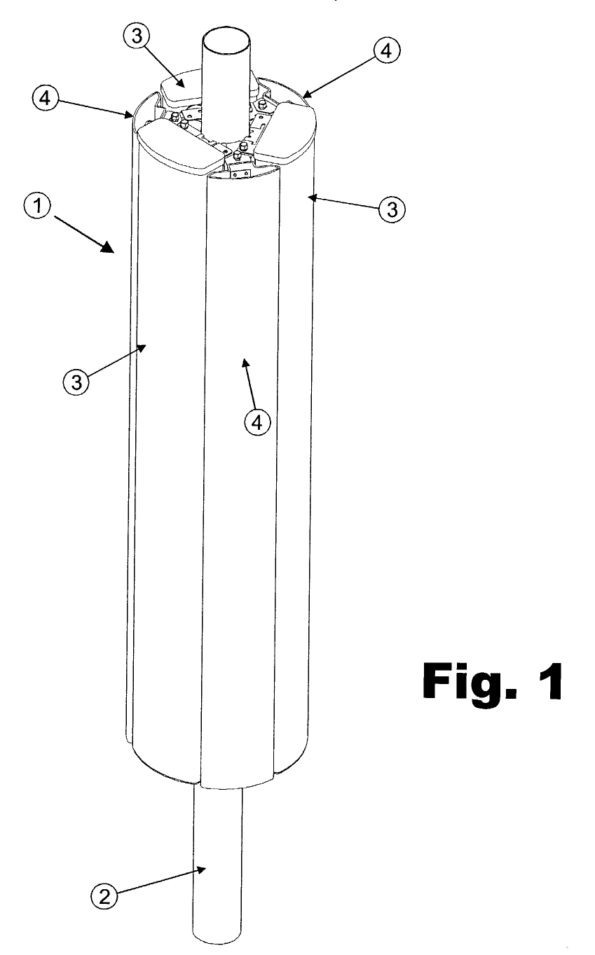

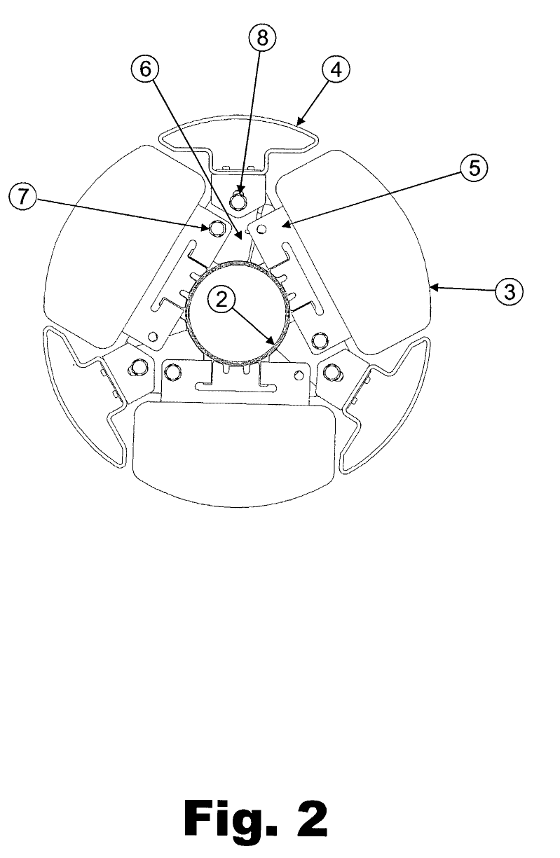

Referring to FIGS. 1 and 2, a cellular communication system microsite antenna assembly 1 comprises a cylindrical mast 2, three identical panel antennas 3; and three identical filler panels 4.

It will be noted from the view of FIG. 1 that the antennas 3 and panels 4 together present an approximately cylindrical profile.

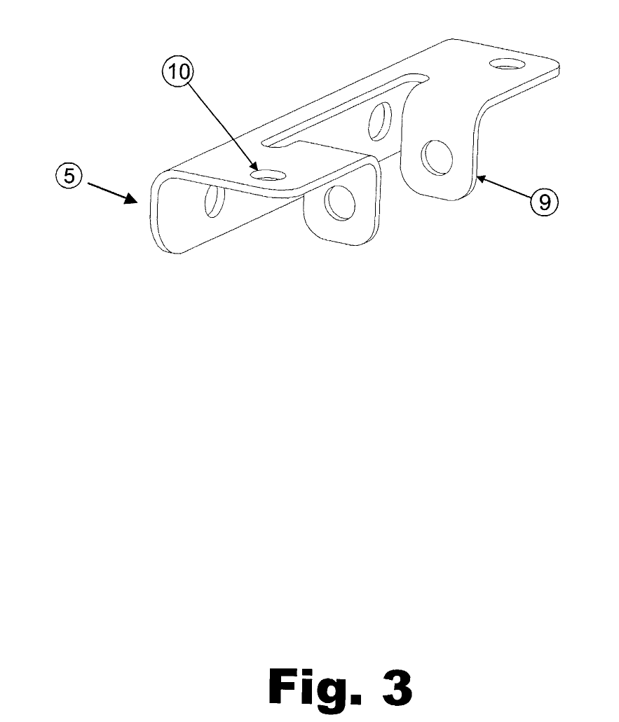

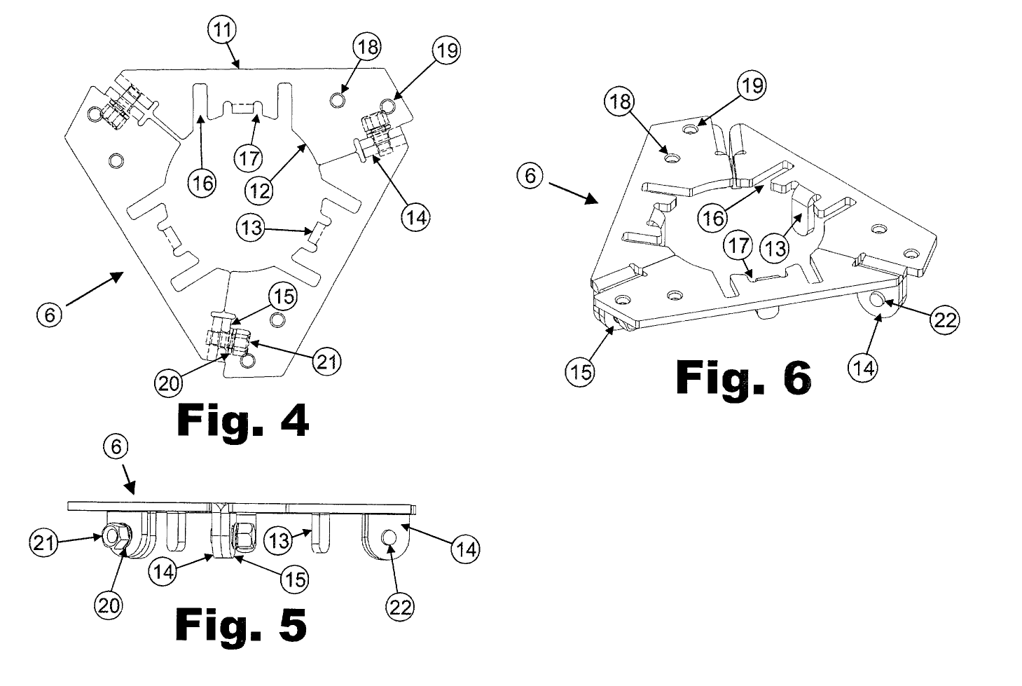

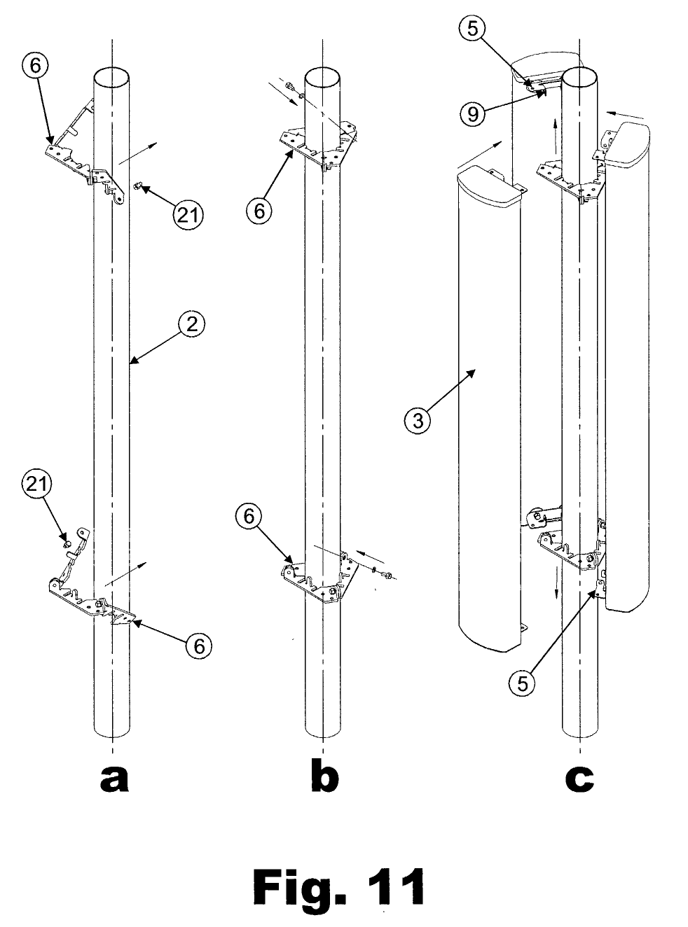

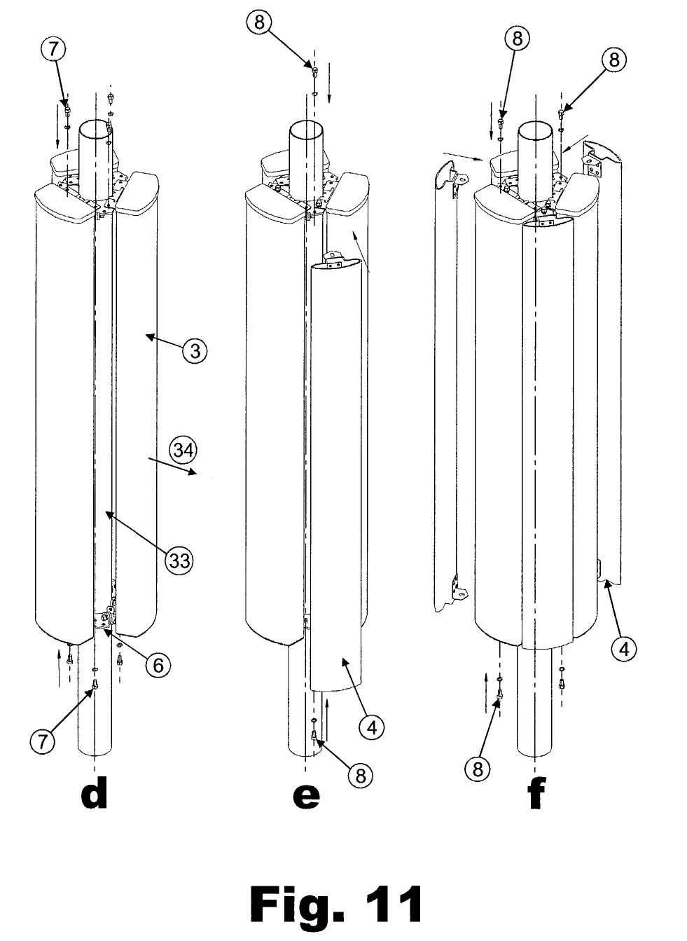

The antennas each have planar rear faces which carry a pair of mounting brackets 5. The upper mounting brackets 5 are shown in FIG. 2, and one of the lower mounting brackets 5 is shown partially in FIG. 11c. The upper and lower mounting brackets 5 are identical although they are mounted on the antenna in opposite orientations (rotated by 180 degrees). The upper and lower mounting brackets 5 each have a pair of arms 9 shown in FIG. 3 which interlock with a respective three-sector clamp 6 shown in detail in FIGS. 4-6.

The clamp 6 is formed by three identical clamping members. Each clamping member has a straight outer side 11 and curved inner side 12 which has a profile shaped to conform with the shape of the mast 2. The member is formed from a planar stainless steel sheet with tabs which are folded down to form spring arm 13 and mounting lugs 14,15. The inner side 12 is formed with a pair of mounting slots 16 and a pair of smaller slots 17. A pair of mounting holes 18,19 are provided at one end.

The lug 15 is formed with a hole (not labelled) which receives a screw 21. The threaded shank of the screw 21 is received in a threaded hole 22 in the lug 14. A spring washer 20 is also provided.

It will be noted that each clamping member is identical. This high symmetry results in low manufacturing costs because only a single tool is required to fabricate the three parts. By providing three tightening screws 21, the clamp can be securely tightened around a mast, and can also adapt to a mast which is not precisely circular. The screws 21 can be adjusted as necessary to give a relatively loose fit, or a relatively tight fit. Also, the screws 21 can be adjusted to account for small changes in mast diameter.

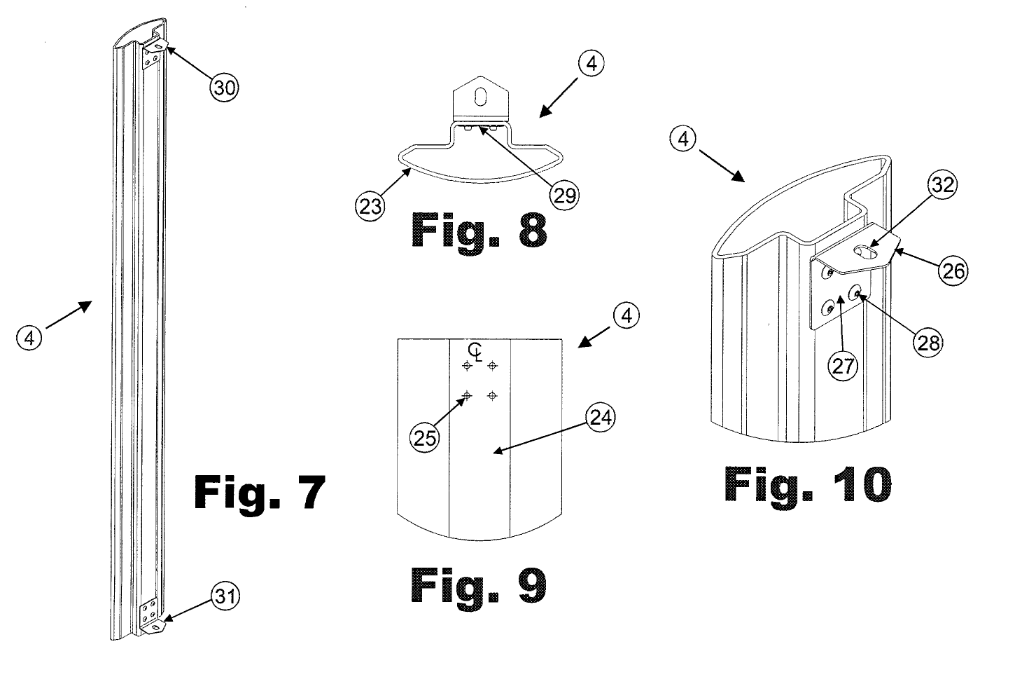

Referring now to FIGS. 7-10, a filler panel 4 is shown, comprising a hollow shell with a curved outer face 23, and an inner face with a rib 24 with four holes 25. A pair of L-shaped mounting brackets 30,31 with a horizontal arm 26 and vertical arm 27 are attached to the rib 24 by rivets 28 and plate 29. The horizontal arm 26 has a mounting slot 32.

A method of assembling the antenna assembly is now described with reference to FIGS. 11a-11f. In a first step shown in FIG. 11a, upper and lower clamps 6 are partially disassembled by removing one of the screws 21. This enables the clamps 6 to be opened as shown in FIG. 11a, and then closed around the mast 2 as shown in FIG. 11b, where upper clamp 6 has arm 13 and lugs 4,15 pointing down and lower clamp 6 has arm 13 and lugs 14,15 pointing up. The screws 21 are then inserted and partially tightened to fix the clamps loosely in place. The screws 21 in the upper clamp are then fully tightened so as to fix the upper clamp securely in place. The panel antennas 3 are then suspended from the upper clamp 6 by inserting arms 9 into mounting slots 16.

The spring arms 13 act as ‘springs’ (essentially biting into the mast) during the tightening of the clamp around the mast. This helps prevent axial slippage. By not engaging the full circumference of the mast or pole, this arrangement compensates for irregularities in diameter as well as other irregularities (for instance due to galvanizing dip build up which gives a rough surface to the mast 2). The spring arms 13 provide higher pressure points (at only three locations), and as a result should have better holding power both axially and radially. The ‘pressure’ per square inch is much higher than if the clamp was engaging with the entire circumference.

The lower clamp 6 (which is only loosely attached to the mast 2) is then slid downwardly, away from the upper clamp, from the position shown in FIG. 11c to the position shown in FIG. 11d in which the arms 9 of the lower brackets are received in the mounting slots 16. The clamp 6 can be accessed via gap 33 between the panel antennas 3, or by pivoting the lower end of one of the panel antennas 3 outwardly as indicated by arrow 34 in FIG. 11d. It will be noted that the mating relationship between the arms 9 of the bracket 5 and the slots 16 allows this pivoting motion (before the screws 7 are inserted). The panel antennas are then secured in place by inserting screws 7 into holes 10 in the upper brackets 5 and hole 18 in the clamp. Screws 7 are also inserted into the lower clamp 6 to fix the lower end of the panel antenna.

Referring to FIG. 11e, the filler panels 4 are then mounted by moving the panels 4 transversely to the mast 2 (i.e. with no motion along the line of the mast) so that the upper arms 26 of the mounting brackets are positioned next to the clamps, with the slot 32 aligned with hole 19 in the clamp. The filler panel 4 is then secured in place top and bottom by a screw 8 passing through slot 32 and hole 19.

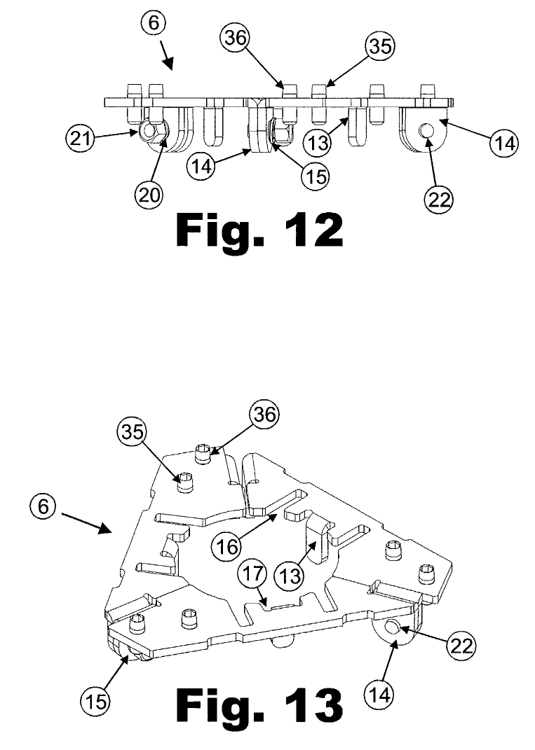

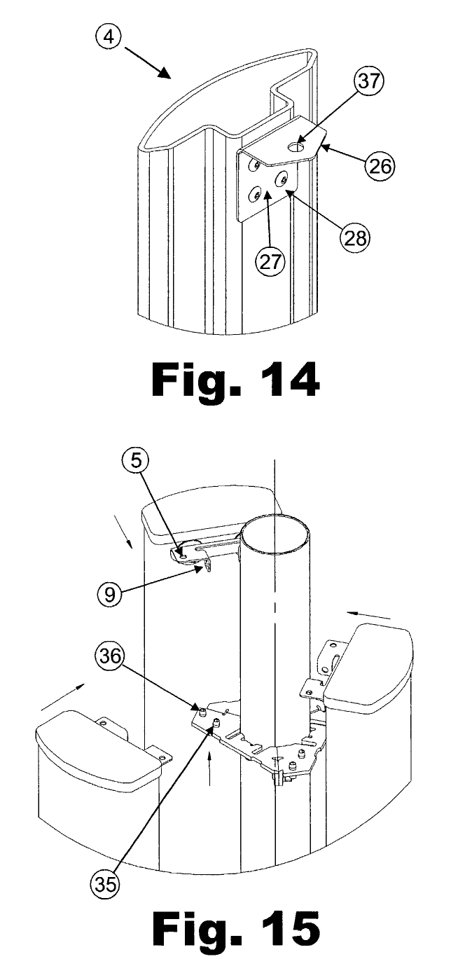

FIGS. 12 to 15 illustrate an alternative top mounting method for both the antenna and the filler panels. Tapered pins 35 and 36 are provided in the top bracket only, to hold the antenna and filler panels respectively. The pins are screwed into the holes 18 and 19 and tapered at the top to locate in the holes 10 in the antenna mounting bracket shown in FIG. 3, and a hole in 37 in an alternative filler panel mounting bracket shown in FIG. 14. The pins 35,36 are fitted to the top bracket 6 before positioning on the mast. Then, when the antenna and filler panels are to be suspended from the top bracket they are gripped from the bottom, lifted over the top bracket as shown in FIG. 15, and slid down into place onto the pins. The bottom bracket is positioned secured as described previously and screws are used to secure the bottom of the antennas/filler panels.

The antennas and filler panels can be suspended by an installer positioned below the upper clamp, without requiring the installer to be lifted up (for instance by a “cherry picker” or similar). The tapered pins 35,36 fit snugly into the holes 10,37 to fix the upper end of the antennas/filler panels securely in place. Although the upper clamp does not secure the antennas/filler panels against upwards movement, this function is achieved by the lower clamp. Therefore, screws 7,8 are not required to secure the antennas/filler panels to the upper clamp. The lower clamp (not shown) does not have tapered pins—it is identical to the lower clamp shown in FIG. 11 and screws 7,8 are used to secure the antennas/filler panels against upwards and downwards movement.

It will be noted that the clamp kit according to the preferred embodiment does not require a band clamp as in the known Kathrein clamp kit nos 742 263, 742 033 and 742 034.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

For instance the tightening screws 21 could be replaced by any suitable tightening means for tightening together a pair of adjacent clamp members. Also, the three sector clamp 6 may be replaced by a two sector clamp, or a clamp with four or more sectors as required. The filler panels 4 may be omitted if aesthetic considerations are not a concern. The embodiment shown involves panel antennas 3 but it will be appreciated that other types of antenna could also be used. It will also be appreciated that some of the steps in FIGS. 11a-f may be performed in a different sequence to the sequence shown. For instance, the lower clamp 6 may not be wrapped round the mast in step 11c as shown: instead the three antennas may suspended from the upper clamp first, and the lower clamp 6 mounted later by pivoting up one of the antennas as indicated as 34 to provide access to the mast.

Each clamp member carries a single protrusion (that is, spring arm 13) for gripping the mast. However it will be appreciated that additional protrusions may be provided if necessary. The spring arm 13 may be replaced by an alternative spring design (for instance a coil spring) which is formed so as to resiliently engage with the mast 2 during tightening. The spring arm 13 is formed with a planar inner gripping surface. However, it will be appreciated that the spring arm 13 may be replaced by alternative gripping protrusions—for instance a line of serrated teeth.

It is therefore intended by the appended claims to cover any and all such applications, modifications and embodiments within the scope of the present invention.

1. A method of mounting an antenna to a support, the method including the steps of: a) mounting first and second clamps to the support; b) tightening the first clamp around the support; c) mounting the antenna to the first clamp; d) after step c), moving the second clamp along the support away from the first clamp into engagement with the antenna; and e) tightening the second clamp around the support.

2. A method according to claim 1 further including the step of: f) mounting a second antenna to the first and second clamps; and g) mounting a filler panel to the first and second clamps in a gap between the first and second antennas.

3. A method according to claim 2 wherein the second clamp is accessed during step d) through the gap between the first and second antennas.

4. A method according to claim 2 further including the step of pivoting the first or second antenna away from the support to provide access to during step d).

5. A method according to claim 2 wherein the filler panel is mounted in step g) after step d).

6. A method according to claim 2 wherein the filler panel is moved into engagement with the first and second clamps in step g) with substantially no movement of the filler panel in a direction parallel to a line between the first and second clamps.

7. A method according to claim 1 wherein the second clamp is partially tightened around the support in step a), and fully tightened around the support in step e).

8. A method according to claim 1 wherein the antenna and the second clamp having interlocking male and female parts which couple together during step d).

9. A method according to claim 8 wherein the second clamp has a female part which receives a male part of the antenna during step d).

10. A method according to claim 1 wherein the antenna and the first clamp have interlocking male and female parts which couple together during step c).

11. A method according to claim 10 wherein the first clamp has a female part which receives a male part of the antenna during step c).

12. A method according to claim 10 wherein the antenna also has a female part which receives a male part of the first clamp during step c).

13. A method according to claim 12 wherein the male part of the clamp is a tapered pin.

14. A method according to claim 1 wherein the antenna is a panel antenna.

15. A method of mounting an antenna to a support, the method including the steps of: a) mounting a clamp to the support at an elevated position; b) gripping the antenna below its upper end; c) lifting the upper end of the antenna over the clamp mounted at the elevated position; d) lowering the upper end of the antenna onto the clamp so that interlocking male and female parts of the clamp and the antenna couple together; and e) securing a lower end of the antenna to the support.

16. A method according to claim 15 wherein the clamp has a female part which receives a male part of the antenna during step d).

17. A method according to claim 15 wherein the antenna has a female part which receives a male part of the clamp during step d).

18. A method according to claim 17 wherein the male part of the clamp is a tapered pin.

19. A clamp for mounting three or more antennas to a support, the clamp comprising three or more clamping members which can be mounted around the support, and three or more tighteners which can each be adjusted to tighten together a respective pair of adjacent clamping members so as to tighten the clamp around the support.

20. A clamp according to claim 19 wherein each clamping member has an inner side for gripping the support, and one or more mounting slots on the inner side of the clamping member for receiving a mating part of an antenna.

21. A clamp according to claim 19 wherein each clamping member is configured to support a respective antenna and a respective filler panel.

22. A clamp according to claim 19 wherein each tightener includes a screw having a threaded shaft coupled to one clamping member and a head coupled to an adjacent clamping member.

23. A clamp according to claim 19 wherein each clamping member has one or more female parts for interlocking with a corresponding male part of an antenna.

24. A clamp according to claim 19 wherein each clamping member has one or more male parts for interlocking with a corresponding female part of an antenna.

25. A clamp according to claim 24 wherein the male parts are tapered pins.

26. An antenna assembly including three or more antennas mounted to a support by a clamp according to claim 1.

27. An assembly according to claim 26 wherein the antennas are panel antennas.

28. An assembly according to claim 26 further including three or more filler panels each mounted between a respective pair of antennas.

29. An assembly according to claim 28 wherein the antennas and filler panels together present a substantially cylindrical exterior profile.

30. An antenna assembly including three or more antennas mounted to a support by a clamp according to claim 19.

31. An assembly according to claim 30 wherein the antennas are panel antennas.

32. An assembly according to claim 30 further including three or more filler panels each mounted between a respective pair of antennas.

33. An assembly according to claim 32 wherein the antennas and filler panels together present a substantially cylindrical exterior profile.

34. An antenna mounting kit including a pair of clamps according to claim 19; and six or more mounting members each for coupling a respective antenna to a respective clamping member.

35. A kit according to claim 34 wherein the clamps and mounting members having interlocking male and female parts.

36. A kit according to claim 35 wherein the female parts are slots.

37. A kit according to claim 36 wherein the slots are provided in the clamping members.

38. A kit according to claim 34 wherein the mounting members are L-shaped brackets.

39. An antenna assembly mounting kit including a pair of clamps each having three or more clamping members which can be mounted around a support; six or more antenna mounting members for coupling three or more antennas to the clamps, wherein the clamping members and mounting members have interlocking parts which permit a pivoting motion between each mounting member and its respective clamping member; and six or more securing members for securing the mounting members and clamping members together to prevent said pivoting motion.

40. A kit according to claim 39 wherein the securing members are screws which pass through the mounting members and clamping members.

41. A kit according to claim 39 wherein the clamping members and antenna mounting members having interlocking male and female parts which are shaped to permit the pivoting motion.

42. A kit according to claim 41 wherein the female parts are slots.

43. A kit according to claim 42 wherein the slots are provided in the clamping members.

44. A kit according to claim 43 wherein each clamping member has an inner side for gripping the support, and wherein the slots are provided on the inner sides of the clamping members.

45. A kit according to claim 39 wherein the antenna mounting members are L-shaped brackets.

46. A kit according to claim 39 further including six or more filler panel mounting members each for coupling a respective filler panel to a respective clamping member.

47. A kit according to claim 46 wherein the filler panel mounting members are L-shaped brackets

48. An antenna assembly including three or more antennas mounted to a support by a kit according to claim 39.

49. An assembly according to claim 48 wherein the antennas are panel antennas.

50. An assembly according to claim 48 further including three or more filler panels each mounted between a respective pair of antennas.

51. An assembly according to claim 50 wherein the antennas and filler panels together present a substantially cylindrical exterior profile.

52. A clamping member for mounting an antenna to a support, the clamping member having a body portion with an inner side with one or more protrusions for gripping the support.

53. A clamping member according to claim 52 wherein the inner side carries only a single protrusion for gripping the support.

54. A clamping member according to claim 52 wherein the or each protrusion is a spring which is formed so as to resiliently engage with the support during tightening.

55. A clamping member according to claim 52 wherein the or each protrusion is an arm having an elongate side for gripping the support.

56. A clamping member according to claim 52 wherein the or each protrusion has a substantially planar surface for gripping the support.

57. A clamping member according to claim 52 including one or more mounting slots on the inner side of the clamping member for receiving a mating part of an antenna.

58. A clamping member according to claim 52 configured to support a respective antenna and a respective filler panel.

59. A clamping member according to claim 52 including a tightener which can be adjusted to tighten the clamping member together with an adjacent clamping member.

60. A clamp comprising three or more clamping members according to claim 52 which can be mounted around a support; and three or more tighteners which can each be adjusted to tighten together a respective pair of adjacent clamping members so as to tighten the clamp around the support.

61. An antenna assembly including three or more antennas mounted to a support by a clamp according to claim 60.

62. An assembly according to claim 61 wherein the antennas are panel antennas.

63. An assembly according to claim 61 further including three or more filler panels each mounted between a respective pair of antennas.

64. An assembly according to claim 63 wherein the antennas and filler panels together present a substantially cylindrical exterior profile.

65. An antenna mounting kit including a pair of clamps according to claim 52; and six or more mounting members each for coupling a respective antenna to a respective clamping member.

66. A kit according to claim 65 wherein the clamps and mounting members having interlocking male and female parts.

67. A kit according to claim 66 wherein the female parts are slots.

68. A kit according to claim 67 wherein the slots are provided in the clamping members.

69. A kit according to claim 65 wherein the mounting members are L-shaped brackets.
